(19) United States
(12) Patent Application Publication
(10) Pub. No.: US 2021/0142101 A1
(43) Pub. Date: May 13, 2021

(54) SYSTEM AND METHOD FOR PREPROCESSING SEQUENTIAL VIDEO IMAGES FOR FIRE DETECTION BASED ON DEEP LEARNING AND METHOD OF TRAINING DEEP LEARNING NETWORK FOR FIRE DETECTION

(71) Applicant: Electronics and Telecommunications Research Institute, Daejeon (KR)

(72) Inventors: In Su JANG, Daejeon (KR); Kwang Ju KIM, Daegu (KR); Seung Woo NAM, Daejeon (KR); Yun Won CHOI, Daegu (KR)

(73) Assignee: Electronics and Telecommunications Research Institute, Daejeon (US)

(21) Appl. No.: 17/091,543

(22) Filed: Nov. 6, 2020

(30) Foreign Application Priority Data
Nov. 8, 2019 (KR) 10-2019-0142332

(51) Int. Cl. G06K 9/46; G06K 9/00

(52) U.S. Cl. CPC G06K 9/4652; G06K 9/00711

(57) ABSTRACT

Provided are a system and method for preprocessing sequential video images for fire detection based on deep learning and a method of training a deep learning network for fire detection. The system includes a selector configured to select a plurality of sequential images in streaming data as one set, a converter configured to convert color information of the plurality of selected sequential set images into spectral reflectance information using preset standard color space feature information, a filtering part configured to filter the plurality of sequential set images of which the color information is converted into the spectral reflectance information through a fire color filter, and a fire map generator configured to generate one fire map image by compressing the plurality of filtered sequential set images.

### CROSS-REFERENCE TO RELATED APPLICATION

This application claims priority to and the benefit of Korean Patent Application No. 10-2019-0142332, filed on Nov. 8, 2019, the disclosure of which is incorporated herein by reference in its entirety.

### BACKGROUND

### 1. Field of the Invention

The present invention relates to a system for preprocessing sequential video images for fire detection based on deep learning, and more particularly, to a preprocessing technology for improving deep learning performance to recognize whether fire is present from a real-time video.

### 2. Discussion of Related Art

With the development of deep-learning based video recognition technology, a variety of services are appearing on the basis of the technology.

Objects having a fixed shape generally show a very high recognition rate. Therefore, various technologies, such as a people counting service through person recognition and a traffic estimation and tracking service through vehicle recognition, are being commercialized.

However, in the case of fire recognition, the color and shape of fire are not fixed and vary. Therefore, even a deep learning technology based on a large amount of data shows a low recognition rate.

Since a system including heat sensors, smoke sensors, etc. for fire detection operates after fire spreads somewhat, initial extinguishment is not possible.

On the other hand, thermal video cameras which are frequently used are expensive, and a recognition rate thereof is degraded with an increase in the distance from a target.

Meanwhile, closed-circuit televisions (CCTVs) monitor surroundings of people all the time. Therefore, if fire can be recognized through videos, CCTVs can show more effective results than any other sensor.

For this reason, various fire detection technologies have been proposed on the basis of video analysis.

According to most fire detection technologies, the color of fire is simply defined on the basis of red, yellow, and orange to estimate time-series motion information of fire so that fire is estimated on the basis of the motion information.

However, these technologies misrecognize fire when an object or lighting of a color similar to fire or an object which shows similar motion to fire is present. Consequently, it is difficult to commercialize products based on the technologies.

### SUMMARY OF THE INVENTION

The present invention is directed to providing a system for preprocessing sequential video images for fire detection based on deep learning whereby fire information including fire color information and time-series fire motion information is extracted from video data to recognize fire.

Objects of the present invention are not limited to that mentioned above, and other objects not mentioned above will be clearly understood by those of ordinary skill in the art from the following description.

According to an aspect of the present invention, there is provided a system for preprocessing sequential video images for fire detection based on deep learning, the system including a selector configured to select a plurality of sequential images in streaming data as one set, a converter configured to convert color information of the plurality of selected sequential set images into spectral reflectance information using preset standard color space feature information, a filtering part configured to filter the plurality of sequential set images of which the color information is converted into the spectral reflectance information through a fire color filter, and a fire map generator configured to generate one fire map image by compressing the plurality of filtered sequential set images.

The selector may select three sequential images as one set using encoding and decoding information.

The standard color space feature information may be information derived through input-output relationships using relationships between red-green-blue (RGB) information acquired by imaging color charts and a spectral reflectance of each color chart.

The standard color space feature information may be spectral reflectance information of 31 channels of RGB data provided at intervals of 10 nm within a range from 400 nm to 700 nm.

The fire color filter may filter light in a wavelength range from 570 nm to 700 nm.

The fire map generator may compress the filtered sequential set images into one value through a weighted sum.

The fire map generator may calculate a standard deviation of each spectral distribution and add the calculated standard deviations to the sequential images to perform achromatic correction.

According to another aspect of the present invention, there is provided a method of preprocessing sequential video images for fire detection based on deep learning, the method including selecting, by a selector, a plurality of sequential images in input streaming data as one set, converting, by a converter, color information of the plurality of selected sequential set images into spectral reflectance information, filtering, by a filtering part, the plurality of sequential set images including the spectral reflectance information through a fire color filter, and compressing, by a fire map generator, the plurality of filtered sequential set images to generate one fire map image.

The selecting of the plurality of sequential images may include selecting three sequential images as one set.

The converting of the color information may include imaging color charts of 31 channels, generating a standard red-green-blue (sRGB) color characterization model using spectral reflectance information of each channel, and then converting the color information of the input sequential set images into spectral reflectances using the generated sRGB color characterization model.

Standard color space feature information may be spectral reflectance information of the 31 channels of RGB data provided at intervals of 10 nm within a range from 400 nm to 700 nm.

The fire color filter may filter light in a wavelength range from 570 nm to 700 nm.

The generating of the fire map image may include compressing the filtered sequential set images into one value through a weighted sum.

The generating of the fire map image may further include calculating a standard deviation of reflectances to achromatically correct the generated fire map image.

The generating of the fire map image may include correcting a size of the generated fire map image.

According to another aspect of the present invention, there is provided a method of training a deep learning network for fire detection, the method including selecting, by a selector, a plurality of sequential images in input streaming data as one set, converting, by a converter, color information of the plurality of selected sequential set images into spectral reflectance information, filtering, by a filtering part, the plurality of sequential set images through a fire color filter, compressing, by a fire map generator, the plurality of filtered sequential set images to generate one fire map image, and training an arbitrary deep learning network with the generated fire map image.

The method may further include making an inference about one image in streaming data through the arbitrary deep learning network which is trained with the fire map image.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a system for preprocessing sequential video images for fire detection based on deep learning according to an exemplary embodiment of the present invention;

FIG. 2 is a diagram illustrating an image conversion process according to the exemplary embodiment of the present invention;

FIG. 3 is a reference graph illustrating an application range of a fire color filter according to the exemplary embodiment of the present invention;

FIG. 4 is a reference graph illustrating states before and after application of a fire color filter according to the exemplary embodiment of the present invention;

FIG. 5 is a flowchart illustrating a method of preprocessing sequential video images for fire detection based on deep learning according to the exemplary embodiment of the present invention; and

FIG. 6 is a flowchart illustrating a method of training a deep learning network for fire detection according to another exemplary embodiment of the present invention.

### DETAILED DESCRIPTION OF EXEMPLARY EMBODIMENTS

Advantages and features of the present invention and methods for achieving them will be made clear from embodiments described below in detail with reference to the accompanying drawings. However, the present invention is not limited to the embodiments disclosed below and can be embodied in various different forms. Rather, these embodiments are provided so that this disclosure will be thorough and complete and will fully convey the scope of the invention to those of ordinary skill in the art. The scope of the present invention is merely defined by the claims. Meanwhile, terminology used in this specification is for the purpose of describing the embodiments and is not intended to limit the present invention. Unless the context clearly indicates otherwise, the singular forms include the plural forms as well. The terms “comprises” and/or “comprising,” when used herein, specify the presence of stated elements, steps, operations, and/or device and do not preclude the presence or addition of one or more other elements, steps, operations, and/or devices.

Hereinafter, exemplary embodiments of the present invention will be described with reference to the accompanying drawings. FIG. 1 is a block diagram of a system for preprocessing sequential video images for fire detection based on deep learning according to an exemplary embodiment of the present invention.

As shown in FIG. 1, the system for preprocessing sequential video images for fire detection based on deep learning according to the exemplary embodiment of the present invention includes a selector 100, a converter 200, a filtering part 300, and a fire map generator 400.

The selector 100 selects a plurality of sequential images in streaming data as one set. In this exemplary embodiment, streaming data may be video streaming information which is a closed-circuit television (CCTV) output or streaming video data which represents fire information well in previously stored video data.

In general, fire recognized by a person includes not only color and shape information but also time-series changes therein. To reflect such information, as shown in FIG. 2, a plurality of, that is, three, sequential images are selected for each fire map to be finally output. To select the sequential images, encoding and decoding information of the plurality of sequential images is used. In other words, the selector 100 may select images by considering a frame rate (e.g., 30 fps=30 Hz) of a plurality of input sequential images and a change rate (10 Hz) of general fire so that motion of fire may be reflected as much as possible.

The converter 200 converts color information of the plurality of selected sequential set images into spectral reflectance information. In general, it is difficult to extract fire information from captured red-green-blue (RGB) data. Therefore, the converter 200 converts input RGB sequential images into spectral reflectance information of 31 channels (400 nm to 700 nm, 31 channels at intervals of 10 nm) through a spectrum-based camera characterization process.

The converter 200 generally uses standard color space feature information derived through input-output relationships using relationships between RGB information acquired by imaging color charts and a spectral reflectance of a used color chart. The standard color space feature information is information derived through input-output relationships using relationships between RGB information acquired by imaging color charts and a spectral reflectance of each color chart.

The standard color space feature information may be spectral reflectance information of the 31 channels of RGB data provided at intervals of 10 nm within a range from 400 nm to 700 nm.

Modeling such input-output relationships with an equation, a reference table, or the like is referred to as a color characterization process.

Since each individual camera an error may occur for each camera, it is necessary to perform an accurate color characterization process for optimal results.

However, most cameras conform to the standard RGB (sRGB) color space, color conversion may be simply performed using the sRGB color space. In other words, assuming that a color space of an output RGB signal of a camera accurately corresponds to the sRGB color space, a color characterization model may be derived using spectral reflectances of color patches of color charts and RGB values of the color charts in the sRGB color space.

Subsequently, the filtering part 300 filters the plurality of sequential set images of which the color information is converted into the spectral reflectance information through a fire color filter. Since spectral distribution information acquired through the camera color characterization process includes every piece of color information, fire colors are filtered to extract only fire-related information as shown in FIG. 3.

In FIG. 3, the vertical axis of a fire color filter denotes a corresponding value, and the horizontal axis denotes the visible light region.

The fire color filter filters light in a wavelength range from about 570 nm, at which the yellow color, that is, the color of fire, begins, to 700 nm within the visible light region between 400 nm and 700 nm.

Therefore, the fire color may be extracted through a simple filtering process. FIG. 4 is a graph for comparing states before and after application of a fire color filter. The vertical axis denotes a color value, and the horizontal axis denotes the number of filtering operations.

For example, as shown in FIG. 4, the fire color filter may be used to process spectral distribution information. As shown in FIG. 4 which shows the states before and after filtering, filtering reduces values of the green and blue regions and increases values of the yellow and red regions with respect to input spectral distributions.

Subsequently, the fire map generator 400 generates one fire map image by compressing the filtered three sequential set images. The fire map generator 400 compresses filtered wavelength-specific spectral distributions which represent fire information into one value through a weighted sum.

The fire map generator 400 may perform achromatic correction by calculating and adding the standard deviation of each spectral distribution to the sequential images.

In other words, when fire which is excessively brighter than the surroundings is imaged by a general camera, the exposure of a captured video is excessively high, and color values of the fire are acquired as maximum values (R=255, G=255, B=255) in many cases.

On the other hand, smoke is achromatic, that is, colorless. Consequently, in order to recognize smoke, it is necessary to consider achromatic colors. To reflect this, the standard deviation of each spectral distribution is calculated and added to fire information so that achromatic correction may be performed.

Subsequently, the calculated fire information is corrected according to the RGB data size (0 to 255). A single-channel fire map is generated through this process.

According to this exemplary embodiment of the present invention, to determine whether fire is present, color information of a plurality of sequential images is converted into corresponding spectral reflectance information, and the converted sequential images are filtered and then compressed into one fire map. Consequently, the exemplary embodiment can be applied to various existing deep learning networks for object recognition without additional tasks.

A method of preprocessing sequential video images for fire detection based on deep learning according to the exemplary embodiment of the present invention will be described below with reference to FIG. 5.

First, the selector 100 selects a plurality of sequential images in input streaming data as one set (S610). In the operation S610 of selecting the plurality of sequential images as one set, three sequential images may be selected as one set.

Subsequently, the converter 200 converts color information of the plurality of selected sequential set images into spectral reflectance information (S620). In the operation S620 of converting the color information into the spectral reflectance information, color charts of 31 channels are imaged, an sRGB color characterization model is generated using the spectral reflectance information of each channel, and then color information of the input sequential set images is converted into spectral reflectances using the generated sRGB color characterization model. Here, standard color space feature information may be spectral reflectance information of the 31 channels of RGB data provided at intervals of 10 nm within a range from 400 nm to 700 nm.

Subsequently, the filtering part 300 filters the plurality of sequential set images including the spectral reflectance information with a fire color filter (S630). The fire color filter filters light in a wavelength range from 570 nm to 700 nm.

Then, the fire map generator 400 generates one fire map image by compressing the plurality of filtered sequential set images (S640). In the operation S640 of generating the fire map image, the filtered sequential set images are compressed into one value through a weighted sum.

Also, in the operation S640 of generating the fire map image, the generated fire map image may be achromatically corrected by calculating a standard deviation of spectral reflectances.

In the operation S640 of generating the fire map image, the size of the corrected fire map image may be corrected.

A method of training a deep learning network for fire detection according to another exemplary embodiment of the present invention will be described below with reference to FIG. 6.

First, a selector 100 selects a plurality of sequential images in input streaming data as one set (S710).

Subsequently, a converter 200 converts color information of the plurality of selected sequential set images into spectral reflectance information (S720).

Then, a filtering part 300 filters the sequential set images including the spectral reflectance information with a fire color filter (S730).

Subsequently, a fire map generator 400 generates one fire map image by compressing the plurality of filtered sequential set images (S740).

An arbitrary deep learning network is trained with the generated fire map image (S750).

In this way, an inference may be made about one image in streaming data through the arbitrary deep learning network which is trained with the fire map image.

In other words, the arbitrary deep learning network may be trained with the plurality of sequential images which are finally output, and in the inference process, an image may be converted and applied in the same way. Therefore, it is possible to detect fire on the basis of deep learning using one fire map without analyzing a plurality of sequential images.

According to the exemplary embodiments of the present invention, in order to determine whether fire is present in a streaming video, color information of a plurality of sequential images is converted into corresponding spectral reflectance information, and the converted sequential images are filtered and then compressed into one fire map. Consequently, the exemplary embodiment can be applied to various existing deep learning networks for object recognition without additional tasks.

Since results of preprocessing are the same as existing input images, the exemplary embodiment can be directly applied to general deep learning networks.

In the case of detecting a fire (fire and smoke) having an atypical shape varying over time, a target to be recognized has time-series information. Therefore, existing deep learning networks for handling time-series information are complicated and perform a large amount of calculation, and thus commercialization is difficult. On the other hand, according to the present invention, time-series information is compressed and stored in an image during a preprocessing operation. Therefore, even when a general deep learning network is used only, performance can be improved without an additional network for handling time-series information.

The embodiments of the present invention have been described in detail above with reference to the accompanying drawings. However, the embodiments are merely exemplary, and various modifications and alterations can be made by those of ordinary skill in the art without departing from the scope of the present invention. Consequently, the scope of the present invention is defined not by the above-described embodiments but by the following claims.

What is claimed is:

1. A system for preprocessing sequential video images for fire detection based on deep learning, the system comprising:
a selector configured to select a plurality of sequential images in streaming data as one set;
a converter configured to convert color information of the plurality of selected sequential set images into spectral reflectance information using preset standard color space feature information;
a filtering part configured to filter the plurality of sequential set images of which the color information is converted into the spectral reflectance information through a fire color filter; and
a fire map generator configured to generate one fire map image by compressing the plurality of filtered sequential set images.

2. The system of claim 1, wherein the selector selects three sequential images as one set using encoding and decoding information.

3. The system of claim 1, wherein the standard color space feature information is information derived through input-output relationships using relationships between red-green-blue (RGB) information acquired by imaging color charts and a spectral reflectance of each color chart.

4. The system of claim 3, wherein the standard color space feature information is spectral reflectance information of 31 channels of RGB data provided at intervals of 10 nm within a range from 400 nm to 700 nm.

5. The system of claim 4, wherein the fire color filter filters light in a wavelength range from 570 nm to 700 nm.

6. The system of claim 1, wherein the fire map generator compresses the filtered sequential set images into one value through a weighted sum.

7. The system of claim 1, wherein the fire map generator calculates a standard deviation of each spectral distribution and adds the calculated standard deviations to the sequential images to perform achromatic correction.

8. A method of preprocessing sequential video images for fire detection based on deep learning, the method comprising:
selecting, by a selector, a plurality of sequential images in input streaming data as one set;
converting, by a converter, color information of the plurality of selected sequential set images into spectral reflectance information;
filtering, by a filtering part, the plurality of sequential set images including the spectral reflectance information through a fire color filter; and
compressing, by a fire map generator, the plurality of filtered sequential set images to generate one fire map image.

9. The method of claim 8, wherein the selecting of the plurality of sequential images comprises selecting three sequential images as one set.

10. The method of claim 8, wherein the converting of the color information comprises:
imaging color charts of 31 channels;
generating a standard red-green-blue (sRGB) color characterization model using spectral reflectance information of each channel; and
converting the color information of the input sequential set images into spectral reflectances using the generated sRGB color characterization model.

11. The method of claim 10, wherein standard color space feature information is spectral reflectance information of the 31 channels of RGB data provided at intervals of 10 nm within a range from 400 nm to 700 nm.

12. The method of claim 11, wherein the fire color filter filters light in a wavelength range from 570 nm to 700 nm.

13. The method of claim 8, wherein the generating of the fire map image comprises compressing the filtered sequential set images into one value through a weighted sum.

14. The method of claim 13, wherein the generating of the fire map image further comprises calculating a standard deviation of reflectances to achromatically correct the generated fire map image.

15. The method of claim 8, wherein the generating of the fire map image comprises correcting a size of the generated fire map image.

16. A method of training a deep learning network for fire detection, the method comprising:
selecting, by a selector, a plurality of sequential images in input streaming data as one set;
converting, by a converter, color information of the plurality of selected sequential set images into spectral reflectance information;
filtering, by a filtering part, the plurality of sequential set images through a fire color filter;
compressing, by a fire map generator, the plurality of filtered sequential set images to generate one fire map image; and
training an arbitrary deep learning network with the generated fire map image.

17. The method of claim 16, further comprising making an inference about one image in streaming data through the arbitrary deep learning network which is trained with the fire map image.
